(19) United States
(12) Patent Application Publication
(10) Pub. No.: US 2015/0072757 A1
(43) Pub. Date: Mar. 12, 2015

(54) GAME MACHINE AND METHOD USING PLAY LINE INDICATORS

(71) Applicant: Atlas Gaming Technologies Pty. Ltd., Port Melbourne (AU)

(72) Inventors: DANIEL JULIO MONTENEGRO, Port Melbourne (AU); ZENJA SOLAJA, Port Melbourne (AU); ROBERT SLOOT, Port Melbourne (AU); ALESSANDRO CIAMPOLI, Port Melbourne (AU); BORIS MITLEMAN, Port Melbourne (AU); WADE CLARK, Port Melbourne (AU)

(73) Assignee: Atlas Gaming Technologies Pty. Ltd., Port Melbourne (AU)

(21) Appl. No.: 14/260,429

(22) Filed: Apr. 24, 2014

(30) Foreign Application Priority Data
Apr. 24, 2013 (AU) AU2013901428

(51) Int. Cl. G07F 17/34; G07F 17/32

(52) U.S. Cl. CPC G07F 17/34; G07F 17/3213
USPC 463/20

(57) ABSTRACT

Embodiments relate generally to gaming machines, gaming systems and gaming methods. An example gaming machine includes a display to display images; a user interface to receive input in relation to displayed screen images; a memory; and a game controller configured to access the memory, control display of the images and process input received via the user interface. The game controller controls generation and display of a game play sequence comprising a presentation of one or more games of chance, stores in the memory data describing at least one selected play line, wherein the at least one selected play line comprises a distinct pattern of game symbols appearing at a conclusion of the one or more games of chance, displays in the presentation a selected play line indication of each at least one selected play line. The selected play line indication is positioned at or near a periphery of the display.

### CROSS-REFERENCE TO RELATED APPLICATIONS

The present application claims priority from Australian Provisional Patent Application No 2013901428 filed on Apr. 24, 2013, the content of which is incorporated herein by reference.

### TECHNICAL FIELD

Described embodiments relate generally to gaming machines and methods of controlling such machines. Particular embodiments relate to gaming machines and methods using play line indicators to indicate selected patterns of symbols appearing in a game of chance played on such gaming machines.

### BACKGROUND

In a gaming system involving gaming machines, it is known for a player to place a wager on a possible game outcome from among a number of possible outcomes in a game of chance. Depending on the actual outcome that occurs, the player may win or lose the wager.

Some gaming machines may offer a player the option to make multiple wagers by allowing the player to select more than one possible game outcome as a winning outcome. This can be done by allowing the player to select multiple play lines, where each play line comprises a specific pattern of symbols appearing at the conclusion of the game of chance.

In order for the player to engage effectively with the use of multiple play lines, each selected and available play line should be distinctively identifiable by the player. When the number of available selections is low (e.g. three or fewer play lines), the player can easily distinguish each play line. However, when the number of play lines is high (e.g. five or more), the player may find it difficult to easily identify each selected and available play line.

It is desired to address or ameliorate one or more shortcomings or disadvantages associated with prior gaming machines and/or game play techniques, or to at least provide a useful alternative thereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Some embodiments relate to a gaming machine, comprising:
a display to display images;
a user interface to receive input in relation to displayed screen images;
a memory; and
a game controller configured to access the memory, control display of the images and process input received via the user interface, the game controller further configured to:
   control generation and display of a game play sequence comprising a presentation of one or more games of chance,
   store in the memory data describing at least one selected play line, wherein the at least one selected play line comprises a distinct pattern of game symbols appearing at a conclusion of the one or more games of chance,
   display in the presentation a selected play line indication of each at least one selected play line, wherein the selected play line indication is positioned at or near a periphery of the display and indicates which one or more of a plurality of selectable play lines are active for a succeeding game of chance,
   determine in one or more games of chance whether each at least one selected play line is a winning play line, and
   for each selected play line that is determined to be a winning play line, control display of images to: graphically emphasise the respective selected play line indication, display a winning amount adjacent the respective play line indication, and/or display a unique identifier of the winning play line.

Each play line indication may have a graphical patch associated therewith, which may be shaped like a tab, for example. The plurality of selectable play lines may be displayed as a series of play line indications, which may extend along a side or top/bottom edge of the display, for example. The play line indications representing inactive play lines may be displayed with a transparent graphical patch while the play line indications representing active play lines may be displayed with an opaque graphical patch. All selectable play lines may be grouped together and may be non-overlapping.

The pattern of symbols of each selectable play line may comprise a linear or non-linear line pattern that does not double back on itself. For example, each selected play line may not intersect with more than one symbol in each column of symbols displayed within a field of play in the game of chance.

Each play line indication may have a unique identifier, which may comprise a number of the play line, for example. This unique identifier may be displayed over the graphical patch for the respective play line indication during selected times or events, such as when indicating a winning play line, when selected play lines change or when displaying a help sequence, for example.

In some embodiments, a summary indication of selected and selectable play lines may be displayed adjacent a display of the plurality of selectable play lines. The summary indication may indicate how many of the selectable play lines are selected for the succeeding game of chance and may indicate a total of how many play lines are selectable.

Each play line indication at or near the periphery of the display may be matched by a corresponding play line indication at or near an opposite periphery of the display. In such embodiments, the game controller may be further configured, for each selected play line that is determined to be a winning play line, to control display of images to: graphically emphasise the respective corresponding selected play line indication, display a winning amount adjacent the respective corresponding play line indication, and/or display a unique identifier of the winning play line in relation to the corresponding play line indication.

In some embodiments, when multiple selected play lines are determined by the game controller to be winning play lines, the game controller is configured to graphically emphasise the selected play line indications of all of the winning play lines simultaneously and optionally to subsequently sequentially emphasise each of the selected play line indications of the winning play lines separately. For multiple winning play lines, the game controller is further configured to display one or more of the winning play lines in a differentiating manner to allow separate visual identification of each winning play line. In some embodiments, the game of chance includes a bonus symbol and when at least one of the winning play lines comprises the bonus symbol, each at least one winning play line comprising the bonus symbol may be graphically emphasised relative to winning play lines that do not comprise the bonus symbol. This graphical emphasis may include displaying the winning play line including the bonus in a different colour to the winning play line that does not include the bonus.

The storing of the data describing at least one selected play line in the memory may be performed by the game controller in response to received user input that indicates at least one play line selection corresponding to the at least one selected play line.

In some embodiments, the game controller is further configured to, in response to determining that a selected play line is a winning play line, sequentially graphically indicate a series of symbols in the selected pattern of symbols that forms the winning play line. This sequential graphical indication may include visibly drawing a line that sequentially connects each of the series of symbols. The line may also be illustrated as originating from the play line indication of the winning play line. Where a corresponding play line indication is displayed on the opposite periphery, the line drawn to connect the series of symbols (in the selected pattern of symbols that forms the winning play line) may be illustrated as terminating at the corresponding play line indication.

Some embodiments relate to a gaming system comprising at least one gaming machine as described above and at least one server system in communication with the game controller of the at least one gaming machine.

Some embodiments relate to a method of game play executed by a computerised game controller, the method comprising:
controlling generation and display of a game play sequence comprising a presentation of one or more games of chance;
storing in a memory data describing at least one selected play line, wherein the at least one selected play line comprises a distinct pattern of game symbols appearing at a conclusion of the one or more games of chance;
displaying in the presentation a selected play line indication of each at least one selected play line, wherein the selected play line indication is positioned at or near a periphery of the display and indicates which one or more of a plurality of selectable play lines are active for a succeeding game of chance;
determining in one or more games of chance whether each at least one selected play line is a winning play line; and
for each selected play line that is determined to be a winning play line, controlling display of images to: graphically emphasise the respective selected play line indication, display a winning amount adjacent the respective play line indication, and/or display a unique identifier of the winning play line.

Some embodiments relate to computer-readable storage storing executable program code that, when executed by a game controller, causes the game controller to perform the methods described above and/or implement the features and functions of the game machine or game system described above.

Some embodiments relate to a gaming system comprising at least one server and at least one client device, wherein the at least one server and at least one client device are configured to cooperate with each other to execute program instructions to:
control generation and display of a game play sequence comprising a presentation of one or more games of chance;
store in a memory data describing at least one selected play line, wherein the at least one selected play line comprises a distinct pattern of game symbols appearing at a conclusion of the one or more games of chance;
display in the presentation a selected play line indication of each at least one selected play line, wherein the selected play line indication is positioned at or near a periphery of the display and indicates which one or more of a plurality of selectable play lines are active for a succeeding game of chance;
determine in one or more games of chance whether each at least one selected play line is a winning play line; and
for each selected play line that is determined to be a winning play line, control display of images to: graphically emphasise the respective selected play line indication, display a winning amount adjacent the respective play line indication, and/or display a unique identifier of the winning play line.

### BRIEF DESCRIPTION OF DRAWINGS

Embodiments are described in further detail below, by way of example and with reference to the accompanying drawings, in which:

FIG. 1 is a perspective view of a gaming machine;

FIG. 2 is a block diagram of game logic circuitry of the gaming machine illustrated in FIG. 1;

FIG. 3 is a block diagram of functional components of a gaming system incorporating gaming machines illustrated in FIG. 1;

FIG. 4 is an example display portion of a gaming machine display, the display portion illustrating example display line indications;

FIG. 5 is an example gaming machine display illustrating generation of a winning play line indication;

FIG. 6 is an example gaming machine display illustrating generation of multiple winning play line indications; and

FIG. 7 is an example gaming machine display illustrating generation of multiple visually differentiated winning play line indications.

### DETAILED DESCRIPTION

Described embodiments generally relate to gaming systems and methods of controlling such systems. Particular embodiments relate to gaming machines and methods using play line indicators to indicate selected patterns of symbols appearing in a game of chance played on such gaming machines.

The gaming system can take a number of different forms. In a first form, a stand-alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in standalone gaming machine mode, “thick client” mode or “thin client” mode depending on the game being played, operating conditions, and so on. Other variations will be apparent to persons skilled in the art.

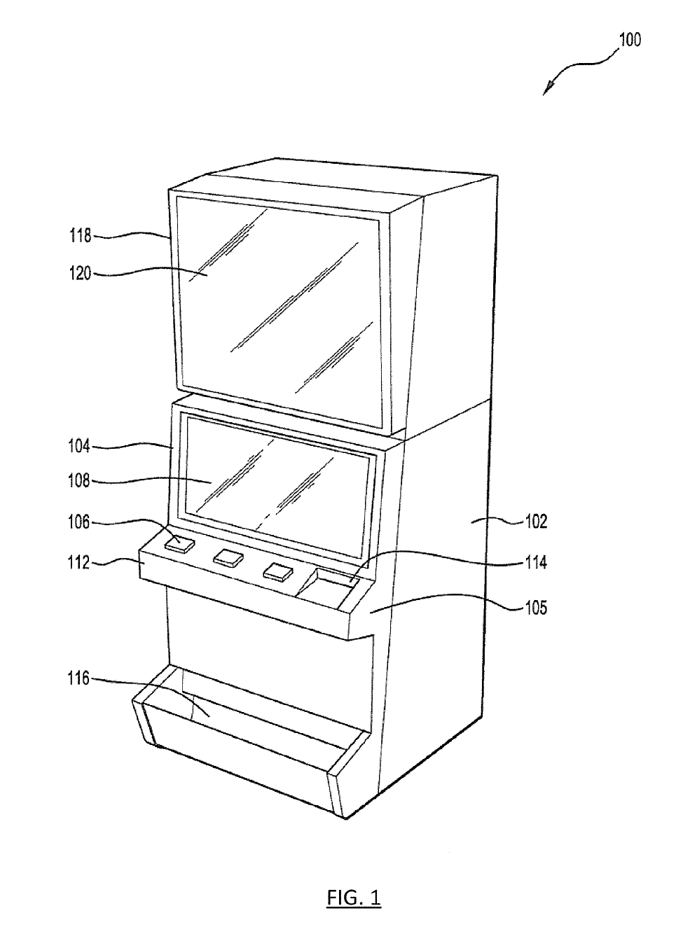

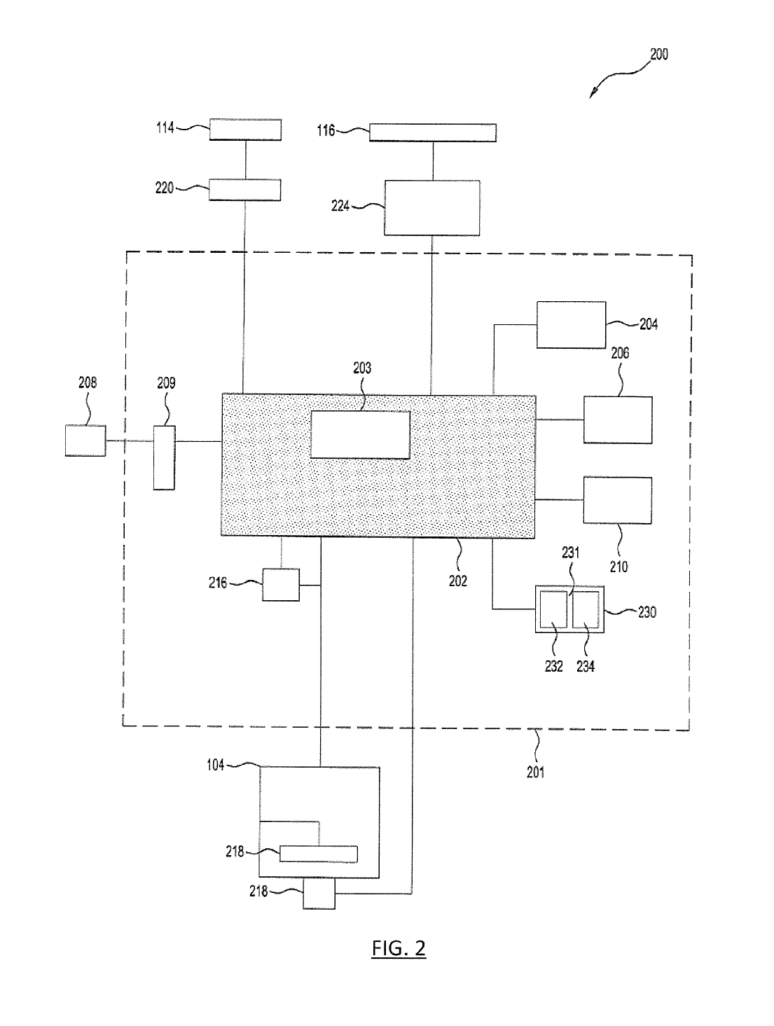

In another form, the gaming system may comprise a gaming server (or multiple gaming servers) interacting with client computing devices over a wired and/or wireless network to allow performance of the games on the client devices. Such client devices may include desktop computers, tablet computers, laptop computer and handheld computing devices (including smart phones), for example, each of which includes at least one processor and memory to store executable instructions for performing the game-related functions described herein. Such systems may therefore not require specific dedicated physical gaming machines as described herein in relation to FIGS. 1 and 2, since the client devices can in such systems perform some of the gaming functions as described herein. In such gaming systems, the client devices may locally execute gaming applications that communicate with the gaming server and, in combination with the gaming server, provide a user interface and gaming experience generally similar to that of a physical gaming machine. Thus, embodiments described herein in relation to gaming machines may be implemented “on-line” using such a client-server architecture, unless such implementations would not be physically or technologically feasible. Additionally, some embodiments described herein in relation to gaming machines may be implemented in a personal computing device without requiring interaction with a server, in which case such computing devices can be termed “gaming machines”.

One or more of the method steps described in this disclosure may be implemented by executable instructions and parameters 232, 234 (See FIG. 2), stored in the memory 204, 206, 230 (See FIG. 2), that may form software embodiments of the system 100. These instructions 232, 234 that form the system 100 may be executed by the CPU 202 (See FIG. 2) or any other processor. Further, the processor 202, the memory 204, 206, 230, the instructions 232, 234 stored therein, or a combination thereof may serve as a means for performing one or more of the method steps described herein.

Irrespective of the form, the gaming system 100 has several core components. At the broadest level, the core components are a player interface in the form of a touch screen 108 as illustrated in FIG. 1 and a game controller 200 as illustrated in FIG. 2. The player interface is arranged to enable manual interaction between a player and the gaming system and for this purpose includes the input/output components required for the player to enter instructions and play the game.

In FIG. 1, reference numeral 100 generally designates a stand-alone gaming system including a game. By stand-alone the applicant is referring to a system which can operate by itself with a player and which requires no further interaction from other systems. Hereinafter, the stand-alone gaming system 100 will be referred to as a gaming machine.

The gaming machine 100 includes a console 102 which contains all or most components required to implement a game play whereby a player wins or loses a wager. Access to the components is by way of a hinged door 105. Moulded to the exterior of the console 102 is a display means in the form of at least one visual display unit 104 on which one or more games is played. The video display unit 104 may be implemented as a liquid crystal display, a plasma screen, as a cathode ray screen device or the like. Whilst the console 102 illustrated in FIG. 1 shows a single visual display unit 104, there can be more than one visual display unit on a typical machine. What is displayed on the visual display unit 104 will depend on what the intended goal of the unit is in relation to the player and any other potential participants in the gaming system.

The gaming machine includes a tactile input subsystem for a player to interact via touch with the gaming machine 100. In one example, the tactile input subsystem may include a combination of pushbuttons 106 and a touch screen 108 for enabling a player to play one or more games. The touch screen 108 is an electronic visual display that can detect the presence and location of a touch within the display area. The touch screen 108 is used during the game play between start of a game and the end of a game. A game is considered to have started once a wager is placed and considered complete once the wager has been lost or won. Certain functions of the one or more pushbuttons 106 include: initiation of game play, credit output, gameplay selection, completion of gameplay etc. A midtrim 112 of the machine 100 houses the pushbuttons 106.

The tactile input subsystem may optionally or further include a joystick comprising of a stick that pivots on a base and reports its angle or direction to the device it is controlling. The tactile input subsystem may optionally or further include a trackpad/touchpad as an example of a screen navigation component that includes a touch sensor to translate the motion and/or position of a user's fingers to a relative position on screen.

The tactile input subsystem may include any suitable device that enables the player to produce an input signal that is received by the game controller (FIG. 2). Tactile input in the form of pushbuttons 106 and/or regions on touch screen 108 may include a one bet button, a max bet button, or a repeat the bet button, for example. With a one bet button for instance, the player places a bet by pushing the one bet button. The player may increase the bet by one credit each time the player pushes the one bet button.

The midtrim 112 may also house a credit input device including a bill collector 114. The credit input device may further include a coin input chute, a card and/or ticket reader, a magnetic reading head for reading a magnetic stripe card, an electronic reader for a proximity card, a near field communications reader or any other form of electronic, wireless or contact-based reader that can communicate a credit input to the gaming machine.

A credit dispenser in the form of a coin tray 116 is mounted beneath the console 102 and is provided for cash payouts from the machine 100 to the player. A hopper device (not shown) is provided which dispenses coins, or tokens equal to the amount of credit currently on the machine, into the coin tray 116. Aside from the coin tray 116, the credit dispenser may also include a ticket dispenser for issuing a ticket dispensed by a printer which the user can redeem for cash, a note dispenser, a near field (or other) communications transmitter or means to enable remote credit transfer. A variety of suitable payout mechanisms, such as funding to the player's electronically recordable identification card or smart card, may be implemented in accordance with the gaming machine disclosed herein.

The gaming machine 100 includes a top box 118 on which artwork 120 is carried in the form of electronic visual display units. The artwork 120 could also be made from physical materials such as paper, plastic banners or posters. The artwork 120 may have generic information related to the machine or gaming system or the artwork 120 be specifically made for a particular game to be played on the machine 100. Whilst the artwork 120 is shown as being carried on the top box 118, the art work 120 can also be positioned in or on the bottom panel of the door 105, or any other part of the gaming machine 100 visible to the player.

The gaming machine 100 further includes an auditory unit in the form of speakers (not shown) to provide auditory feedback to the player of the gaming machine 100.

Referring to FIG. 2 of the drawings, game logic circuitry 200 is illustrated. The game logic circuitry 200 includes a gaming controller 201 (otherwise referred to as a logic cage) designated by the dashed lines. As will be appreciated by those skilled in the gaming industry, the logic cage 201 includes a box-like mechanical structure that has slots to guide logic cards into the proper location for electronically plugging into a backplane mounted at the rear of the cage structure. The backplane has connectors for accepting mating connectors on the logic cards. The logic cage and associated cards form one of the basic components of the gaming machine 100 and is securely housed within the cabinet of the gaming machine 100.

Central to the logic cage is a central processing unit 202 such as a processor, a microcontroller-based platform, a suitable integrated circuit, or one or more application-specific integrated circuits (ASIC's). The processor 202 is in communication with or operable to access or to exchange signals with an outcome evaluator 203, RAM 204, ROM 206, a non-volatile memory in the form of a compact flash 230, an audio output 208 via an audio control module 209, and a random number generator 210. The audio control module 209 has its own digital signal processor, analogue to digital converters, amplifiers and other circuitry necessary to broadcast the output from the speakers. RAM 204 may include non-volatile RAM (NVRAM), magnetic RAM (MRAM), ferroelectric RAM (FeRAM), and other forms as commonly understood in the gaming industry.

Compact flash memory 230 is physically secured within a slot in the logic cage 201. In one embodiment, the compact flash memory 230 is physically secured inside the logic cage within game logic circuitry 200 by a mechanical locking mechanism. Compact flash memory 230 is partitioned 231 into two parts. A first part comprises a game software module 232 and a second part comprises a metering information module 234.

The processor 202 runs executable code residing in game software module 232 of compact flash 230 that facilitates play of the game by a player through the display device and/or push buttons and touch sensors mounted in the screen 108 of the display. Metering information module 234 contains the gaming machine parameters which include values that would usually be stored on a hard meter. The values in metering information module 234 are only ever incremented, and cannot be reset or decremented. The only way to alter the values stored is by running the executable code stored in game software module 232, the program code of which is executed by processor 202. The executable code of game software module 232 further interacts with the credit dispenser 116 via a payout mechanism 224 and the auditory output 208. The game software module 232 contains the rules of the game, the sequence of gameplay, communicates with external systems, monitors peripheral equipment and maintains integrity of the software code, etc. The processor 202 continually checks for error conditions.

A program which implements the user interface is further run by the central processing unit 202. The processor 202 forms part of a controller 216 that drives the screen of the video display unit 104 and that receives input signals from sensors 218. The sensors 218 include sensors associated with the push buttons and touch sensors mounted in the screen of the visual display unit 104. The controller 214 also receives input pulses from mechanisms 220 and 224 to determine whether or not a player has provided sufficient credit from either payment device 114 or payment device 116 to commence playing.

In one embodiment, a player may insert an identification card into a card reader (not shown) of the gaming machine 100. Such an identification card may be a smart card having a programmed microchip, a coded magnetic strip, or coded rewritable magnetic strip, wherein the programmed microchip or magnetic strips are coded with a player's identification, credit totals (or related data), and/or other relevant information. In another embodiment, a player may carry a portable device, such as a mobile phone, a radio frequency identification tag, or any other suitable wireless device, that communicates a player's identification, credit totals (or related data), and other relevant information to the gaming device.

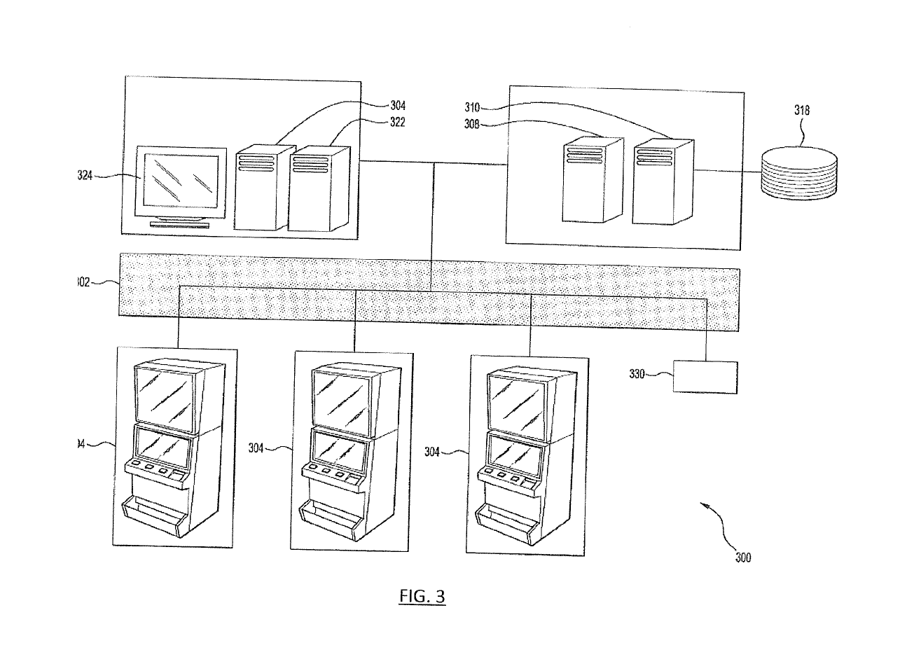

FIG. 3 shows a gaming system 300 in accordance with an alternative embodiment. The gaming system 300 includes a network 302, which for example may be an Ethernet network. The network 302 may also comprise a wide area network (“WAN”), the plain-old-telephone-system (“POTS), a local area network (“LAN”), a wireless LAN, the Internet, or any combination of these and other types of networks. Gaming machines 304 are connected to the network 302. The gaming machines 304 provide a player operable interface and may be the same as the gaming machines 100 shown in FIG. 1 or may have simplified functionality depending on the requirements for implementing game play.

In a thick client embodiment, game server 308 implements part of the game played by a player using a gaming machine 304 and the gaming machine 304 implements part of the game. With this embodiment, as both the game server 308 and the gaming device implement part of the game, they collectively provide a game controller. A database management server 310 may manage storage of game programs and associated data for downloading or access by the gaming devices 304 in a database 318.

In a thin client embodiment, game server 308 implements most or all of the game played by a player using a gaming machine 304 and the gaming machine 304 essentially provides only the player interface. With this embodiment, the game server 308 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 300, including for example a gaming floor management server 320, and a licensing server 322 to monitor the use of licenses relating to particular games. An administrator terminal 324 is provided to allow an administrator to run the network 302 and the devices connected to the network.

The gaming system 300 may communicate with other gaming systems, other local networks, for example a corporate network, and/or a wide area network such as the Internet, for example through a firewall 330.

Persons skilled in the art will appreciate that in accordance with known techniques, functionality at the server side of the network may be distributed over a plurality of different computers. For example, elements may be run as a single “engine” on one server or a separate server may be provided. For example, the game server 308 could run a random number generator engine. Alternatively, a separate random number generator server could be provided. Further, persons skilled in the art will appreciate that a plurality of game servers could be provided to run different games or a single game server may run a plurality of different games as required by the terminals.

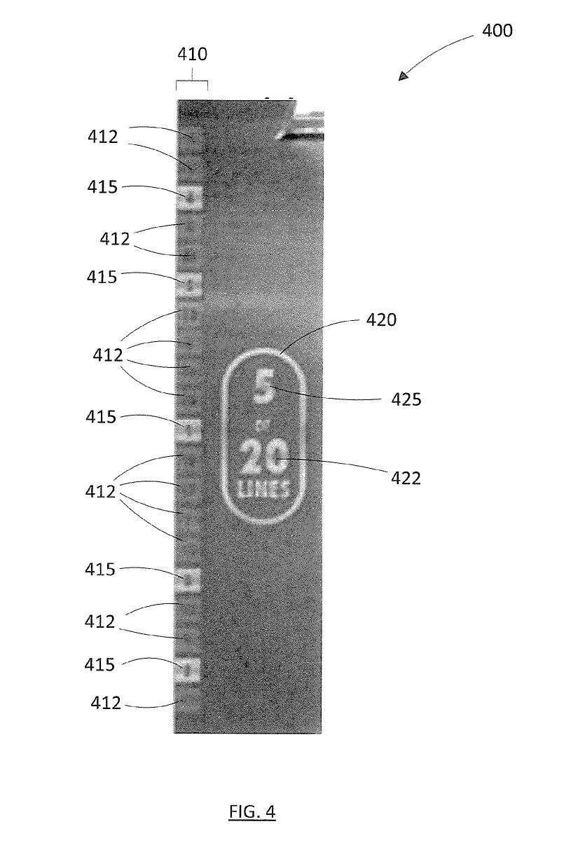

Referring also now to FIGS. 4, 5, 6 and 7, features and functions of game machine 100 and gaming system 300 are described in further detail with respect to display images 400, 500, 600 and 700 generated by execution of code comprised in the game software module 232.

FIG. 4 is a partial display 400 of an image to be displayed on the screen 108. The display 400 illustrates a series of play line indications 410 arranged along a periphery of the display of screen 108. The series of play line indications 410 may be disposed generally along a line (which may be straight or not straight) that is at the edge of the display area of the screen 108 or alternatively is near the edge. The play line indications 410 comprise a series of non-overlapping graphical patches, which may be in the form of tabs, for example. Each play line indication may be selected according to user input to be an active play line for a succeeding game of chance to be played on the game machine 100.

For each play line indication 410 that corresponds to an active play line, an emphasised play line indication 415 is displayed as part of the series of play line indicators 410. For play line indicators 410 that are inactive, a de-emphasised play line indication 412 is shown in the series. Emphasised play line indications 415 may be shown in a graphically opaque manner, while de-emphasised play line indications 412 may be shown in a transparent or translucent manner, for example.

In between successive games of chance, a player may provide selection input via the tactile input subsystem to select or deselect one or more play line indications 410, thereby toggling such play line indications 410 between selected and deselected states. Each selection or deselection of a graphical patch corresponding to a play line indication 410 is stored in the memory of the gaming machine 100 or 304 (either RAM 204 or Flash 230) for use by the processor 202 (executing the code of software module 232) to determine, in cooperation with the outcome evaluator 203, whether a selected play line corresponds with a winning outcome in the game of chance.

FIG. 4 also illustrates a play line selection summary portion 420 that is displayed generally adjacent or nearby the series of play line indications 410 at or near the periphery of the display screen 108. The play line selection summary portion 420 indicates a number 422 of total selectable play lines and also indicates a number 425 of selected play lines (corresponding to the total number of emphasised graphical patches 415 shown in FIG. 4), which is greater than zero and less than or equal to the total number 422 of selectable play lines.

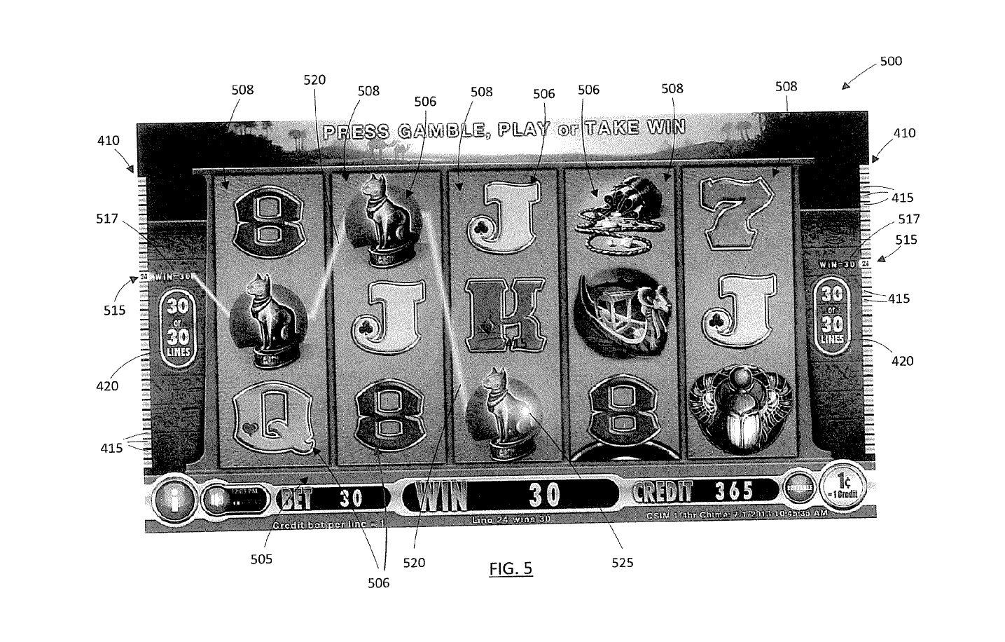

As illustrated in FIG. 5, game play on game machine 100 includes a presentation of one or more games of chance, illustrated by successively generated images displayed on display screen 108. Such images include a field of play 505 that comprises a number of symbols 506. Each of the symbols 506 is notionally one of a (possible lengthy) series of symbols within a same column 508. Each game of chance involves the randomised presentation of a number of symbols 506 within the column 508 (selected from among a larger total set of symbols for that column, including other symbols 506 not shown).

Once the set of symbols 506 to be displayed in the field of play 505 is determined by execution of the game software module 232 in cooperation with the random number generator 210, the game software module 232 generates (in cooperation with a graphics processor) images to be displayed, depicting the set of symbols and, in cooperation with the outcome evaluator 203, determines whether the symbols corresponding to one or more selected play lines comprise a winning combination of such symbols, and if so, it is determined that those one or more selected play lines are winning play lines.

Example selectable play line patterns may include, for example, a straight central line, a straight upper line, a straight lower line, a zig-zagging pattern, a V-shaped pattern, an inverted V-shaped pattern, a W-shaped pattern and an inverted W-shaped pattern, just to name a few. Various other line patterns may be selectable, so long as they include a single symbol position in each column 508 in the field of play 505.

In the example illustrated in FIG. 5, a winning play line 520 has been determined to exist, corresponding to a selected play line 515 that has the unique identifier number 24, as one example. As illustrated in FIG. 5, the winning play line 520 is shown as a graphically drawn line extending from the graphical patch 515 that is one among the series of play indications 410 (all of which are selected play lines 415 in the example shown in FIG. 5). The winning play line 520 is indicated as being generally continuous from the winning play line indicator 515, extending into the field of play 505 and connecting each of the symbols 506 that are in positions defined by the pattern of the winning selected play line. As shown in FIG. 5, the winning play line 520 is graphically represented to appear to travel behind each symbol 506 but to generally travel in front of each other graphical element along its path.

In the example shown in FIG. 5, the winning play line 520 is in the process of being displayed as a line drawn to connect the relevant symbols 506, with the head of the line 525 travelling across the field of play 505 from left to right (although other directions, such as right to left, may be employed in other embodiments). The head 525 of the winning play line 520 may be indicated by a halo, sparkle or other emphasising graphical feature to be easily discernible by the player as it travels across the screen in a manner that illustrates the path of the winning play line from the relevant selected play line indication 515 on one side of the screen to the corresponding play line indication 515 on the other (opposite) side of the screen 108.

Optionally, as part of the display of the winning play line 520, a win description 517 may be displayed adjacent the graphical patch 415 that is emphasised as the winning play line indication 515. This win description 517 may include words and symbols to convey to the player a winning amount associated with the winning outcome of the winning play line. For example, as shown in FIG. 5, the win description 517 is shown as “Win=30” to indicate a winning amount of 30 credits. This win description 517 is displayed in a position intermediate the series of play line indications 410 and the playing field 505 and may be indicated on each opposite side of the display screen 108 adjacent the appropriate winning play line indication 515.

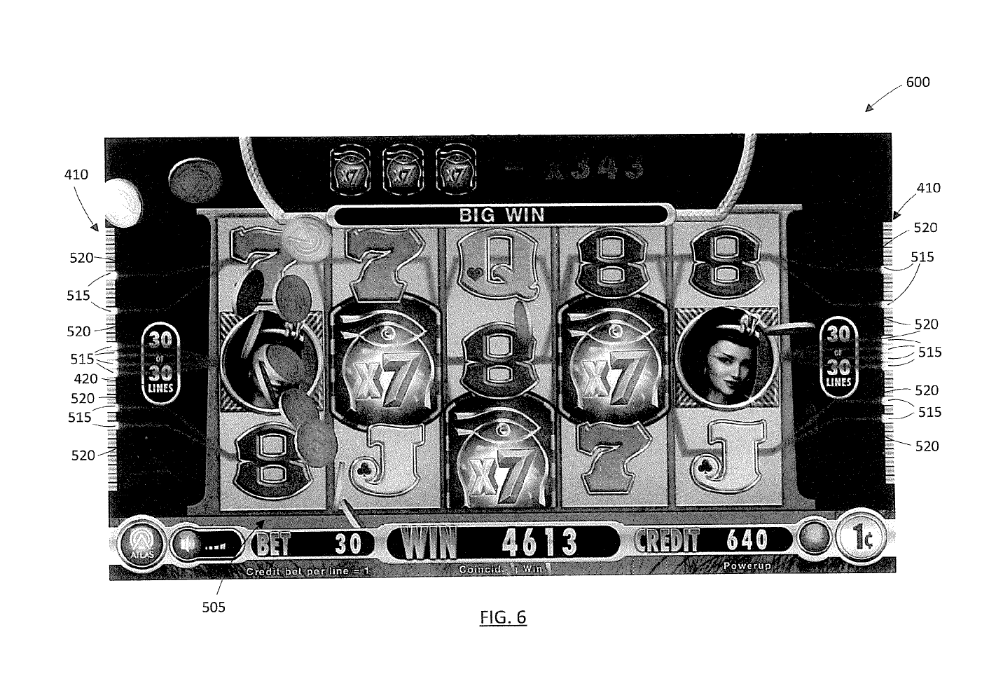

Referring in particular to FIG. 6, an example display 600 illustrates a situation in which eight different selected play lines have been determined to be winning play lines and each of these is indicated by an emphasised graphical patch at the position of the winning play line indication 515. Each winning play line 520 includes a graphically drawn line that extends from the emphasised graphical patch into the field of play 505 and connecting the relevant symbols 506 in the pattern that corresponds to the selected play line that was determined to be a winning play line.

As is evident from the example display 600, where a number of winning play lines are displayed, it can be difficult for a player to discern specific winning play lines from each other. Therefore, all winning play lines may be initially displayed simultaneously, as is shown in FIG. 6, and then optionally subsequently each winning play line can be displayed separately in sequence in the manner illustrated in FIG. 5 (i.e., by drawing the line 520 from the left to the right or the right to the left).

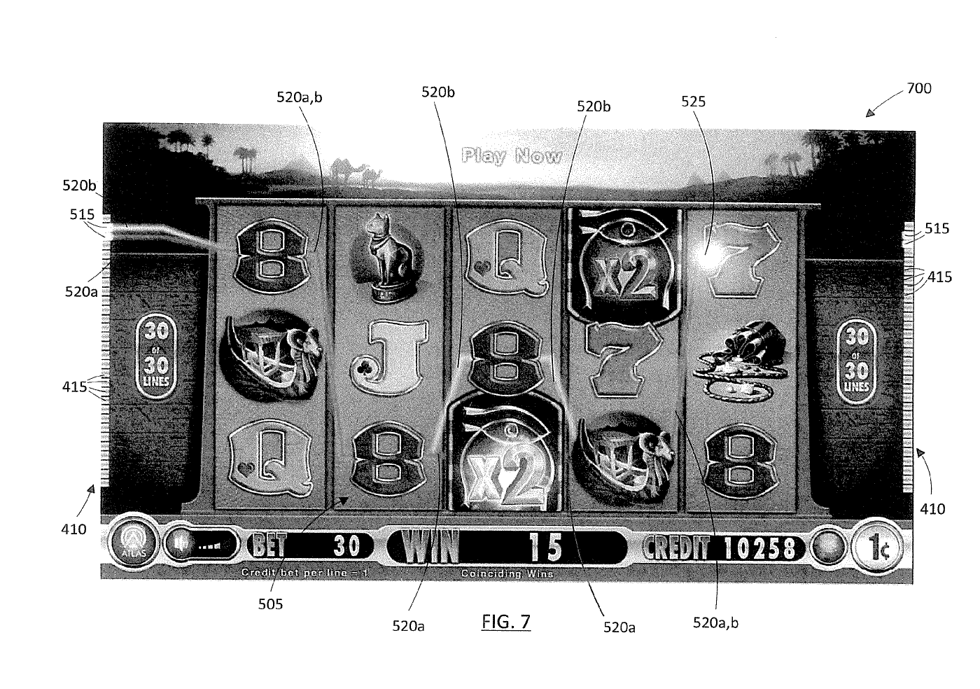

Referring also to FIG. 7, an example display image 700 is shown, illustrating multiple winning display lines 520a and 520b that may partially coincide. Where such winning play lines partially coincide, they may be shown by a single line (and a single colour) and where those winning play lines 520a, 520b do not coincide, they may be shown by different colours, for example. Alternatively, instead of a single line, the winning play lines 520a, 520b may be shown to be visibly distinct but to extend closely adjacent each other where they travel the same path between symbols 506.

In the example shown in FIG. 7, the middle column of symbols shows portions of a second winning play line 520b that are separate and diverge from portions of another winning play line 520a. In the example shown in FIG. 7, both winning play lines 520a, 520b may be drawn simultaneously, with the head 525 of each line splitting and converging appropriately as the winning play lines progress across the field of play 505 or alternatively the winning play lines 520a, 520b may be sequentially drawn.

FIG. 7 also illustrates a situation in which the presence of a bonus symbol within a pattern of symbols matching the winning play line may be represented by differentiating the colour of the winning play line containing that bonus symbol from other winning play lines that do not contain that bonus symbol. Rather than different colours, other forms of differentiation may be used to differentiate between different winning play lines and/or to indicate the presence of a bonus symbol within the pattern of symbols corresponding to the winning play line.

As indicated in FIGS. 5, 6 and 7, when indicating a winning combination of symbols 506, the graphical patch of the winning play line indication 515 is highlighted compared to neighbouring graphical patches that do not correspond to winning play lines. Additionally, a unique identifier of the winning selected play line may be displayed over the graphical patch.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

While the foregoing description has been provided by way of example of the preferred embodiments of the present invention as presently contemplated, which utilise gaming machines of the type found in casinos, those skilled in the relevant arts will appreciate that embodiments of the present invention also may have application to internet gaming and/or have application to gaming over a telecommunications network, where mobile handsets are used to display game outcomes and receive player inputs. Such mobile devices include smart phones, notebooks, tablets, iPads and laptop computers. For instance free mobile device games may be offered for download and play on a players personal mobile device as a bonus game play. In such an embodiment the gaming machine may comprise a power interface to enable interaction between the respective devices and/or a communication or wireless interface to enable data transfer. During game play, the gaming machine may be configured to send information to the player's personal mobile device.

Further embodiments may enable a player to upload the outcome of a game or bonus game to a social media site(s), post tournament scores etc.

Certain steps in the processes or process flows described in this disclosure naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another.

A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention.

1. A gaming machine, comprising:
a display to display images;
a user interface to receive input in relation to displayed screen images;
a memory; and
a game controller configured to access the memory, control display of the images and process input received via the user interface, the game controller further configured to:
control generation and display of a game play sequence comprising a presentation of one or more games of chance,
store in the memory data describing at least one selected play line, wherein the at least one selected play line comprises a distinct pattern of game symbols appearing at a conclusion of the one or more games of chance,
display in the presentation a selected play line indication of each at least one selected play line, wherein the selected play line indication is positioned at or near a periphery of the display and indicates which one or more of a plurality of selectable play lines are active for a succeeding game of chance,
determine in one or more games of chance whether each at least one selected play line is a winning play line, and
for each selected play line that is determined to be a winning play line, control display of images to: graphically emphasise the respective selected play line indication, display a winning amount adjacent the respective play line indication, and/or display a unique identifier of the winning play line.

2. The gaming machine of claim 1, wherein each play line indication has a graphical patch associated therewith,

3. The gaming machine of claim 1, wherein the plurality of selectable play lines is displayed as a series of play line indications.

4. The gaming machine of claim 1, wherein play line indications representing inactive play lines are displayed with a transparent graphical patch while the play line indications representing active play lines are displayed with an opaque graphical patch.

5. The gaming machine of claim 1, wherein all selectable play lines are grouped together and are non-overlapping.

6. The gaming machine of claim 1, wherein each selected play line does not intersect with more than one symbol in each column of symbols displayed within a field of play in the game of chance.

7. The gaming machine of claim 1, wherein each play line indication has a unique identifier and the unique identifier is displayed over the graphical patch for the respective play line indication during selected times or events.

8. The gaming machine of claim 1, wherein a summary indication of selected and selectable play lines is displayed adjacent a display of the plurality of selectable play lines.

9. The gaming machine of claim 8, wherein the summary indication indicates how many of the selectable play lines are selected for the succeeding game of chance and indicates a total of how many play lines are selectable.

10. The gaming machine of claim 1, wherein the game controller is further configured, for each selected play line that is determined to be a winning play line, to control display of images to: graphically emphasise the respective corresponding selected play line indication, display a winning amount adjacent the respective corresponding play line indication, and/or display a unique identifier of the winning play line in relation to the corresponding play line indication.

11. The gaming machine of claim 10, wherein when multiple selected play lines are determined by the game controller to be winning play lines, the game controller is configured to graphically emphasise the selected play line indications of all of the winning play lines simultaneously.

12. The gaming machine of claim 1, wherein the storing of the data describing at least one selected play line in the memory may be performed by the game controller in response to received user input that indicates at least one play line selection corresponding to the at least one selected play line.

13. The gaming machine of claim 1, wherein the game controller is further configured to, in response to determining that a selected play line is a winning play line, sequentially graphically indicate a series of symbols in the selected pattern of symbols that forms the winning play line.

14. The gaming machine of claim 13, wherein the sequential graphical indication includes visibly drawing a line that sequentially connects each of the series of symbols.

15. The gaming machine of claim 14, wherein the line is illustrated as originating from the play line indication of the winning play line.

16. The gaming machine of claim 15, wherein, where a corresponding play line indication is displayed on an opposite periphery of the display, the line drawn to connect the series of symbols is illustrated as terminating at the corresponding play line indication.

17. A gaming system comprising at least one gaming machine according to claim 1 and at least one server system in communication with the game controller of the at least one gaming machine.

18. A method of game play executed by a computerised game controller, the method comprising:
controlling generation and display of a game play sequence comprising a presentation of one or more games of chance;
storing in a memory data describing at least one selected play line, wherein the at least one selected play line comprises a distinct pattern of game symbols appearing at a conclusion of the one or more games of chance;
displaying in the presentation a selected play line indication of each at least one selected play line, wherein the selected play line indication is positioned at or near a periphery of the display and indicates which one or more of a plurality of selectable play lines are active for a succeeding game of chance;
determining in one or more games of chance whether each at least one selected play line is a winning play line; and
for each selected play line that is determined to be a winning play line, controlling display of images to: graphically emphasise the respective selected play line indication, display a winning amount adjacent the respective play line indication, and/or display a unique identifier of the winning play line.

19. Computer-readable storage storing executable program code that, when executed by a game controller, causes the game controller to perform the method of claim 18.

20. A gaming system comprising at least one server and at least one client device, wherein the at least one server and at least one client device are configured to cooperate with each other to execute program instructions to:
control generation and display of a game play sequence comprising a presentation of one or more games of chance;
store in a memory data describing at least one selected play line, wherein the at least one selected play line comprises a distinct pattern of game symbols appearing at a conclusion of the one or more games of chance;
display in the presentation a selected play line indication of each at least one selected play line, wherein the selected play line indication is positioned at or near a periphery of the display and indicates which one or more of a plurality of selectable play lines are active for a succeeding game of chance;
determine in one or more games of chance whether each at least one selected play line is a winning play line; and
for each selected play line that is determined to be a winning play line, control display of images to: graphically emphasise the respective selected play line indication, display a winning amount adjacent the respective play line indication, and/or display a unique identifier of the winning play line.
